(19) United States
(12) Patent Application Publication
(10) Pub. No.: US 2026/0341769 A1
(43) Pub. Date: Oct. 29, 2026

(54) FLOW ARRANGEMENT FOR SUPPLYING A MEDIA FLOW TO INLET OPENINGS OF FUEL CELL STACKS

(71) Applicant: AVL List GmbH, Graz (AT)

(72) Inventor: Robert PÖSCHL, Gratwein-Straßenengel (AT)

(73) Assignee: AVL List GmbH, Graz (AT)

(21) Appl. No.: 19/099,072

(22) PCT Filed: Jul. 27, 2023
(86) PCT No.: PCT/AT2023/060251

§ 371 Date: Jan. 28, 2025

(30) Foreign Application Priority Data
Jul. 28, 2022 (AT) A 50572/2022

(51) Int. Cl. H01M 8/2484; H01M 8/04082; H01M 8/10; H01M 8/12

(52) U.S. Cl. CPC H01M 8/2484; H01M 8/04201; H01M 2008/1095; H01M 2008/1293

(57) ABSTRACT

The present invention relates to a flow arrangement (30) for supplying a media flow (1) to inlet openings (42) of fuel cell stacks (40), wherein the flow arrangement (30) comprises a flow distributor (10) with a main flow section (12) and with auxiliary flow sections (14) branching off from the main flow section (12) for fluidic connection to the inlet openings (42) of the fuel cell stacks (40), and wherein a flow inlet (11) is formed in the main flow section (12) for supplying the media flow (1) into the main flow section (12), wherein the flow arrangement (30) further comprises a flow insert (20) arranged in the main flow section (12) and fluidically coupled with the flow inlet (11), with at least one flow recess (22, 24) for the uniformly distributed supply of the media flow (1) via the main flow section (12) and the auxiliary flow sections (14) to the inlet openings (42).

The present invention relates to a flow arrangement for supplying a media flow to inlet openings of fuel cell stacks, wherein the flow arrangement has a flow distributor with a main flow section and with auxiliary flow sections branching off from the main flow section for fluidic connection to the inlet openings of the fuel cell stacks, and wherein a flow inlet is formed in the main flow section for supplying the media flow into the main flow section. Furthermore, the invention relates to a fuel cell system with a plurality of fuel cell stacks and such a flow arrangement.

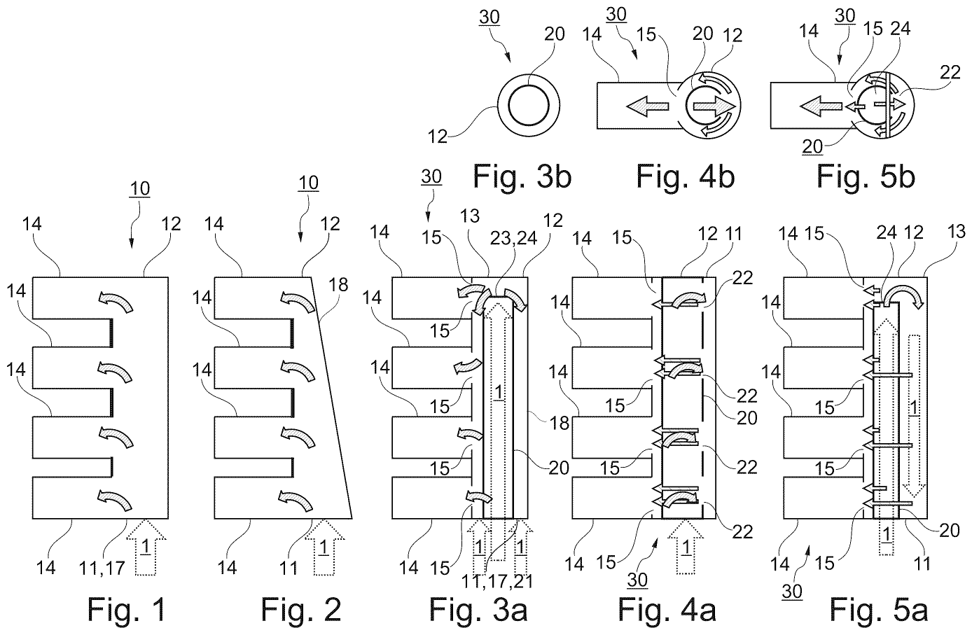

A flow distributor as mentioned above for supplying a media flow to inlet openings of fuel cell stacks is known from the prior art and is shown by way of example and schematically in a cross-sectional view in FIG. 1.

The flow distributor 10 shown in FIG. 1 has a main flow section 12 and auxiliary flow sections 14 branching off from this which can in turn be connected to inlet openings of fuel cell stacks (not shown in FIG. 1). As can also be seen in FIG. 1, a flow inlet 11 is provided on an underside 17, in relation to the orientation shown, of the flow distributor 10, through which a media flow 1 flows into the flow distributor 10 for distribution to the fuel cell stacks.

Due to the fact that the media flow 1 passes from the main flow section 12 through the individual auxiliary flow sections 14 one after the other, due to hydraulic and thermal losses the same mass, temperature and velocity of the medium of the media flow 1 cannot be provided in all auxiliary flow sections 14, whereas this is desirable in order to be able to operate all fuel cell stacks uniformly.

FIG. 2 shows a solution to this problem from the prior art. In contrast to FIG. 1, the main flow section 12 does not have a constant cross-section here, but a cross-section that tapers along its main direction of extension. In the present case, a long second side wall 18 of the main flow section 12 is arranged obliquely to said main direction of extension.

Even if this enables a highly uniform distribution, in terms of mass and velocity, of the supply of the media flow to the auxiliary flow sections 14, an even more highly uniform distribution is desirable.

Particularly with regard to the temperature of the medium of the media flow 1, it can be determined in the case of the flow distributor 10 of FIG. 1 that the temperature of the medium drops sharply towards the auxiliary flow sections 14 which are located further away from the flow inlet 11, namely by several degrees C, which can already have a significant effect on the chemical reaction. This means that the fuel cell stacks are not all supplied uniformly with regard to the flow parameters of the media flow 1 and are therefore increasingly subjected to different loads over their service life, causing greater power losses and ageing and in some cases can no longer be operated as is desirable.

It is the object of the present invention to remedy, at least in part, the disadvantages described above. In particular, it is the object of the present invention to provide, in a cost-effective and simple manner, the most uniform possible distribution of a media flow to individual fuel cells of the fuel cell stacks.

The above object is achieved by a flow arrangement with the features of claim 1 and a fuel cell system with the features of claim 19. Further features and details of the invention are disclosed in the dependent claims, the description and the drawings. Of course, features and details described in connection with the flow arrangement according to the invention also apply in connection with the fuel cell system according to the invention and vice versa, so that with regard to disclosure mutual reference is or can always be made to the individual aspects of the invention.

According to the invention, a flow arrangement for supplying a media flow to inlet openings of fuel cell stacks is provided, wherein the flow arrangement has a flow distributor with a main flow section and with auxiliary flow sections branching off from the main flow section for fluidic connection to the inlet openings of the fuel cell stacks, and wherein a flow inlet is formed in the main flow section, in particular a flow insert arranged therein, for supplying the media flow into the main flow section. The flow arrangement also comprises a flow insert arranged in the main flow section and fluidically coupled with the flow inlet, with at least one flow recess for the uniformly distributed supply of the media flow via the main flow section and the auxiliary flow sections to the inlet openings.

According to the invention, the object is thus achieved through the use of a specially configured flow insert in the main flow section of the flow arrangement. Thus, this flow insert, with its at least one flow recess, is designed for the uniformly distributed supply of the media flow to the auxiliary flow sections and onwards to the inlet openings of the fuel cell stacks. The uniform distribution of the media flow is provided via the at least one flow recess, since the media flow no longer flows into the main flow section at only one point, namely the flow inlet, as in the prior art, but can flow out via at least one further flow recess within the main flow section, which can be positioned anywhere along the flow insert. By guiding the media flow within the flow insert, the media flow is prevented from flowing in a non-uniform manner within the main flow section to the auxiliary flow sections. The use of the flow arrangement according to the invention thus makes it possible to distribute the media flow flowing into the flow distributor through an inlet opening (or, as explained in more detail later, optionally, a plurality of inlet openings) more uniformly, in particular with regard to the mass, temperature and/or velocity of the media flow, to the auxiliary flow sections and thus the inlet openings of the fuel cell stacks. Insofar as reference is made here to uniform distribution, this is not necessarily to be understood as meaning a mathematically perfect uniform distribution, since such a distribution is not practically feasible. Rather, this means that an attempt is made to achieve the maximum or best possible uniform distribution of the media flow with regard to its flow parameters.

The individual fuel cell stacks can be combined in a fuel cell system. The fuel cell system can include other peripherals and devices for operating the individual fuel cell stacks. These can for example include valves, pumps, recirculation fans, etc.

In addition, the flow insert and the flow distributor can be either separate, in particular single-piece, components or an integrally produced flow arrangement. The first variant has the advantage that it makes it easy to retrofit existing flow distributors by equipping them with the flow insert, which can be attached in the main flow section. The second variant has the advantage of simple production, for example using a 3D printing process. Moreover, the flow distributor itself, with its main flow section and the auxiliary flow sections, can also be produced integrally or as a multi-part component.

It can be preferable if at least one of the at least one flow recesses is an intermediate flow recess which is formed between a first end and a second end of the flow insert. The two ends can in particular be longitudinal ends of the flow insert. They can in each case coincide with ends or side walls, such as an upper side and an underside, of the main flow section, or can be arranged thereon. The fact that one or more flow recesses are arranged between these ends as intermediate flow recesses makes possible a uniform distribution of the media flow at the fuel cell stacks, which are arranged between the two ends with their inlet openings at the flow height or along the direction of flow or main direction of extension of the flow insert. This is particularly advantageous if more than two fuel cell stacks are used, i.e. about three, four, five, six or more fuel cell stacks. The number of auxiliary flow sections corresponds in particular to the number of fuel cell stacks, so that in each case one fuel cell stack with its inlet opening can be assigned to a auxiliary flow section, via a fluidic connection.

It can be preferable if the flow insert has a plurality of intermediate flow recesses which are at a distance from one another along a main direction of extension of the flow insert. By providing a plurality of intermediate flow recesses, for example two, three, four or more intermediate flow recesses, the uniform distribution of the media flow to the inlet openings of the fuel cell stacks, especially in terms of temperature, is further improved. Due to the distance between these, which can in particular be a uniform distance, a mutual influencing of individual partial media flows, into which the media flow in the flow insert can be divided by the intermediate flow recesses and which exit from the intermediate flow recesses, is largely avoided or minimised, so that these can be fed to the individual auxiliary flow sections without being influenced.

It can also be preferable if in each case one of the intermediate flow recesses is located at the flow height of one of the auxiliary flow sections. The flow height is understood to be a height measured in the direction of flow of the media flow in the flow insert, i.e. along its main direction of extension, and thus along and past the individual auxiliary flow sections. In other words, each intermediate flow recess is arranged opposite a auxiliary flow section, so that the individual partial media flows of the media flow can flow out of the intermediate flow recesses into the appropriate auxiliary flow sections. It can also be preferable if at least one of the at least one intermediate flow recesses is formed on a side of the flow insert facing away from the auxiliary flow sections, in particular auxiliary flow section openings of the auxiliary flow sections. This allows an in particular radial flow around the flow insert behind the auxiliary flow sections and in the direction of the auxiliary flow sections to be achieved. The media flow channeled in the flow insert can thereby flow out through an intermediate flow recess, as a partial media flow, in the direction of a side wall (referred to herein as the second side wall) of the main flow section, rebounding from this and being deflected in the opposite direction around the flow insert to the auxiliary flow section, in particular at the same flow height. In this way, a partial media flow separated from the media flow in each case can advantageously be provided, in particular for a plurality of auxiliary flow sections and thus fuel cell stacks, whereby these are in each case distributed with a very high degree of uniformity in terms of flow parameters, in particular mass, temperature and velocity. A flow impulse of the media flow is advantageously reduced and the flow of the media flow in the direction of the auxiliary flow sections is particularly well directed. In this way, the most similar possible incident flow surfaces and interactions with locally similar sections of an outer housing can also be achieved for all auxiliary flow sections, so that each auxiliary flow section has to bear the same thermal losses.

In addition or alternatively, it can also be preferable if a flow guide element for guiding the media flow out of the at least one intermediate flow recess through the main flow section into one of the auxiliary flow sections is arranged on at least one of the at least one intermediate flow recesses. The flow guide element can be either straight, inclined (with respect to a vertical or the main axis of extension of the flow insert) and/or curved (in particular in the direction away from the auxiliary flow sections). Furthermore, the flow guide element can be arranged on the previously mentioned facing-away side of the flow insert or alternatively on a side of the flow insert facing the auxiliary flow sections. Of course, intermediate positions are also possible. The flow guide element enables a controlled flow guidance in order to prevent undesirable turbulence or mixing of partial media flows from the flow recesses.

It can be preferable if the at least one flow guide element is designed to generate a flow vortex of the media flow around at least a part of the flow insert and leading into one of the auxiliary flow sections. The length and swirl of the flow vortex can be adjusted via the position of the flow guide element on the one hand and on the other hand through its design, as described above, for example inclined and/or curved. The impulse of the media flow or partial media flow from the flow insert is thereby deflected. This provides a desirable and controlled flow vortex around the flow insert between the (second) side wall of the main flow section and the flow insert to further improve the uniform distribution of the media flow to the fuel cell stacks. In contrast to the previously described variant, in which the partial media flow flows out through an intermediate flow recess on the facing-away side of the flow insert, in this case the partial media flow is not divided at the (second) side wall of the main flow section. This enables a uniform distribution of the media flow while at the same time aligning the media flow well with the auxiliary flow sections.

It can also be preferable if the at least one flow guide element runs between the flow insert and a second side wall of the main flow section of the flow distributor. In particular, the flow guide element can be flow-tight to one side, so that it deflects a flow to one side or only permits this flow to one side. The flow guide element can be for example an integral part of the flow insert and/or the flow distributor or can be attached to one or both of the above. The second side wall of the main flow section is in particular a wall or side surrounding the flow insert. A first side wall and third side wall of the main flow section can in each case be arranged at the end of the main flow section, whereby these can form an upper side and underside of the main flow section.

In addition or alternatively, it can be preferable if at least one of the at least one intermediate flow recesses is formed on a side of the flow insert facing the auxiliary flow sections. Such intermediate flow recesses can be provided as an alternative or in addition to intermediate flow recesses on the facing-away side of the flow insert. For example, either a direct flow to the auxiliary flow section (without flowing around the flow insert) can be achieved, or a partial media flow can be fed to the auxiliary flow section from both sides of the flow insert.

It can also be preferable if the at least one intermediate flow recess is designed in the form of a slit in the flow insert. The slit can for example have a rectangular or oval elongate shape. A slit has a greater extension in the longitudinal direction than in the width direction. In its length, the slit can extend transversely, in particular perpendicularly, to the main direction of extension of the flow insert. It is particularly easy to produce in the flow insert and can have a limited flow cross-section, so as not to allow all the media flow in the flow insert to flow out, but rather only a controlled and limited flow volume.

It can be the case that a second end of the flow insert, remote from the flow inlet, is arranged on a first side wall of the flow distributor. However, alternatively and preferably, it can be the case that one of the at least one flow recesses is an end flow recess which is formed at a second end of the flow insert remote from the flow inlet. In this case the second end is not arranged on the first side wall of the flow distributor, i.e. it is not tight, but is open, through the end flow recess. The end flow recess can take up the entire or almost the entire cross-section of the flow insert, which is then completely open at the second end. This is a comparatively simple way to distribute the media flow uniformly simply from the flow inlet to the upper or, in other words, last in the direction of flow of the media flow, fuel cell stacks, without the latter already losing temperature, mass and/or velocity through flowing to the first fuel cell stacks. Flowing out of the end flow recess, the media flow can rebound from the first side wall and thus flow to the upper or last auxiliary flow sections. As mentioned before, the first side wall can be an upper side of the main flow section, which can in particular be arranged opposite an underside of the main flow section on or near the flow inlet.

It can also be preferable if the flow distributor has at least one further inlet opening for supplying the media flow past the flow insert into the main flow section and/or the inlet opening is designed in such a way that the media flow can be fed past the flow insert into the main flow section. For the latter variant, the inlet opening can be dimensioned accordingly and/or positioned in such a way that it allows not only an inflow of the media flow into the flow insert but also an inflow into the main flow section between the flow insert and its second side wall. Particularly in conjunction with the end flow recesses, this is advantageous because in this case the lower or first auxiliary flow sections can also be well supplied to ensure a uniform distribution of the media flow to the fuel cell stacks.

It can also be preferable if the inlet opening is formed on an inlet section branching off from the main flow section. This is particularly advantageous where installation space in the main direction of extension of the main flow section is limited. Here, too, the inlet opening and thus the inlet section can be located on the previously mentioned first side wall, from which the main flow section can extend, in length and/or in terms of the media flow provided, along its main direction of extension.

It can be preferable if at least one further inlet section branching off from the main flow section with an inlet opening at a distance from the other inlet section is formed on the main flow section. In this way, another media flow can be fed at another point, in particular at a higher point in terms of the flow height, so that in this case an even better distribution of the media flow is made possible.

It can also be preferable if at least two flow inserts are arranged side by side in the flow distributor. The flow inserts can each be supplied with a media flow from a common flow inlet or individual flow inlets. This makes it easy to achieve larger media flows. It is advantageous here to design the main flow section and, if necessary, the auxiliary flow sections with a greater width.

It can also be preferable if the flow insert and/or the main flow section is a tube. The design as a tube is comparatively uncomplicated and particularly cost-effective. Different cross-sections of the tube are conceivable, for example round, square, oval, heart-shaped, a mixture of the above or the like.

In particular, the flow insert is at a distance from the main flow section, most particularly on all sides or radially. In particular, it can be preferable if the flow distributor is arranged concentrically, in particular coaxially, with the main flow section. In this way, a substantially uniform distance can be achieved between the main flow section, in particular its (second) side wall, and the flow insert, through which the media flow, in particular the created partial media flows, can flow in order to reach the auxiliary flow sections.

Finally, it can also be preferable if auxiliary flow section openings of the auxiliary flow sections are of different sizes. The auxiliary flow section openings or, in other words, the inlets of the auxiliary flow sections serve to admit the media flow. They can for example be formed in different sizes by means of appropriate throttle elements on these and/or in the auxiliary flow sections. It is also possible to further optimise the uniform distribution through such differences in the dimensioning of the auxiliary flow section openings, in particular in their diameter. If, for example, more of the media flow were to arrive at the first auxiliary flow sections in the direction of flow of the media flow, an adjustment can be made, by reducing these auxiliary flow section openings in comparison with the auxiliary flow sections located behind in the direction of the flow, in order to achieve a more uniform distribution, because the media flow arriving at the bottom has to pass through a smaller opening cross-section, so that the flow volume is limited. This can also be pursued with the intention of influencing the uniform distribution of the mixing temperatures at the entrance to the auxiliary flow sections. The subject matter of the present invention also includes a fuel cell system with a plurality of fuel cell stacks and a flow arrangement according to the invention, wherein in each case an inlet opening of each of the fuel cell stacks is in each case connected fluidically to a auxiliary flow section of the flow arrangement.

Thus, a fuel cell system according to the invention brings the same advantages as have been explained in detail with reference to the flow arrangement according to the invention.

It can be preferable if the inlet openings of the fuel cell stacks lead to an air side or a fuel side of the fuel cell stacks. Accordingly, the media flow can preferably be an air flow or fuel flow, for example a hydrogen flow.

Of course, it is also possible to use two or more flow arrangements according to the invention in a fuel cell system according to the invention. The flow arrangements can be used for different media and thus for different inlet openings of the fuel cell stacks. For example, one flow arrangement can be used for the air side of the fuel cell stacks and another flow arrangement for the fuel side of the fuel cell stacks. However, even within a plant media system, starting out from a central media supply, a division into subsystems, each with a series of fuel cell stacks, can be advantageous as a multiple application.

Further advantages, features and details of the invention are explained in the following description, in which exemplary embodiments are described in detail with reference to the drawings. In each case schematically:

FIG. 1 shows a vertical cross-sectional view of a flow distributor according to a first exemplary embodiment from the prior art,

FIG. 2 shows a vertical cross-sectional view of a flow distributor according to a second exemplary embodiment from the prior art,

FIG. 3a shows a vertical cross-sectional view of a flow arrangement according to a first exemplary embodiment of the invention,

FIG. 3b shows a horizontal cross-sectional view of the flow arrangement of FIG. 3a,

FIG. 4a shows a vertical cross-sectional view of a flow arrangement according to a second exemplary embodiment of the invention,

FIG. 4b shows a horizontal cross-sectional view of the flow arrangement of FIG. 4a,

FIG. 5a shows a vertical cross-sectional view of a flow arrangement according to a third exemplary embodiment of the invention,

FIG. 5b shows a horizontal cross-sectional view of the flow arrangement of FIG. 5a,

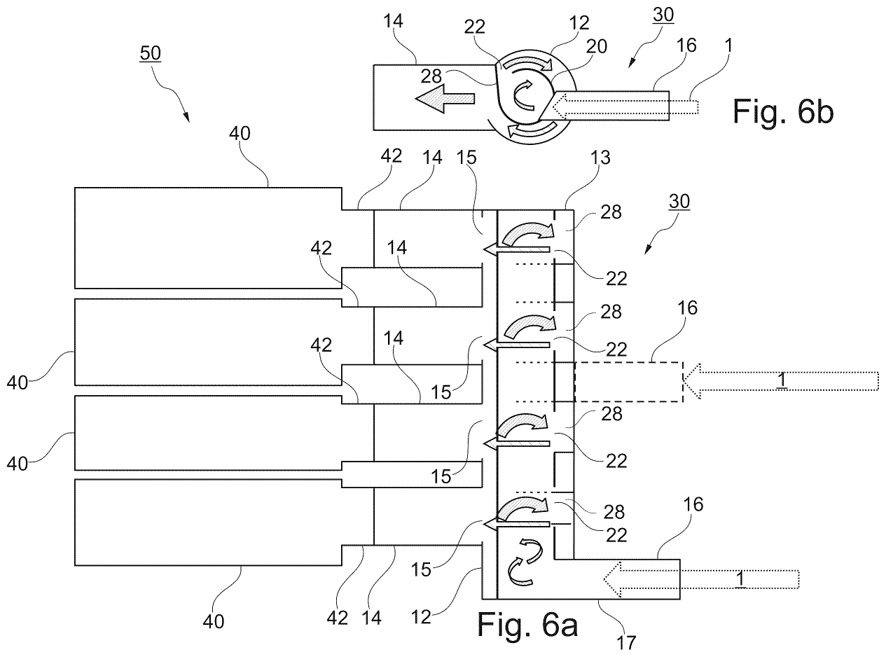

FIG. 6a shows a vertical cross-sectional view of a fuel cell system with a flow arrangement according to a fourth exemplary embodiment of the invention,

FIG. 6b shows a horizontal cross-sectional view of the flow arrangement of FIG. 6a,

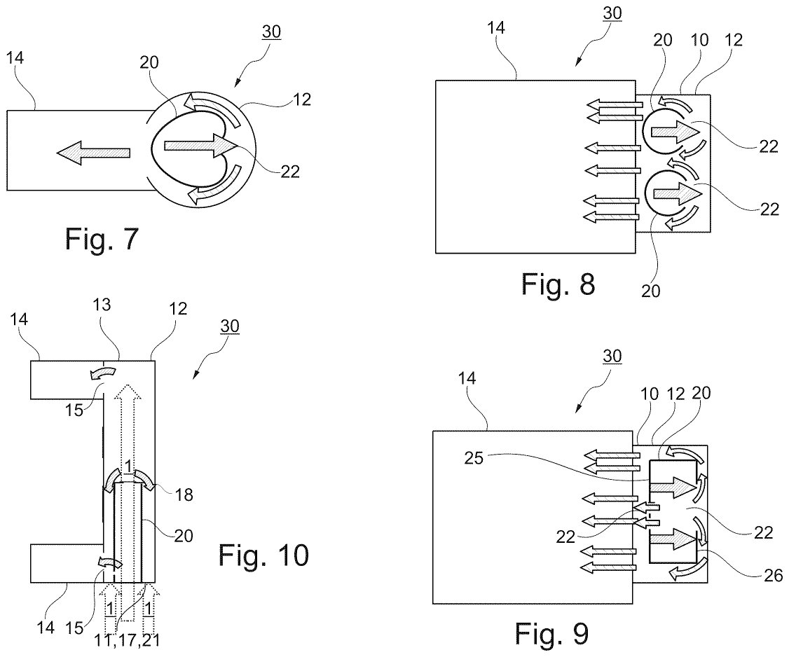

FIG. 7 shows a horizontal cross-sectional view of a flow arrangement according to a fifth exemplary embodiment of the invention,

FIG. 8 shows a horizontal cross-sectional view of a flow arrangement according to a sixth exemplary embodiment of the invention,

FIG. 9 shows a horizontal cross-sectional view of a flow arrangement according to a seventh exemplary embodiment of the invention, and

FIG. 10 shows a vertical cross-sectional view of a flow arrangement according to an eighth exemplary embodiment of the invention.

Identical or functionally identical elements are in each case designated with the same reference sign in FIGS. 1 to 10.

Of course, the terms horizontal and vertical are not to be understood restrictively, but are only chosen to clarify the spatial relationship between the illustrations.

FIG. 3a shows an exemplary embodiment of a flow arrangement 30 according to the invention which, compared to the flow distributor 10 known from the prior art, is improved by a flow insert 20 as well as further measures, as will be explained in more detail below. The flow arrangement 30 is shown here in a vertical cross-section along the main direction of extension, in particular the longitudinal direction of extension, of the flow insert 20, which also corresponds to the flow direction of the fed media flow 1. The flow insert 20 is arranged in a main flow section 12 of the flow distributor 10, which forms a main flow channel here. The flow insert 20 is arranged at a distance from a second side wall 18 of the main flow section 12 which surrounds the flow insert 20 as the outer wall of the main flow section 12. In particular, the flow insert 20 is arranged concentrically within the main flow section 12.

The main flow section 12, the auxiliary flow sections 14 and/or the flow inserts 20 can be tubular in form, as shown in FIG. 3b, in contrast to FIG. 3a, in a horizontal cross-section through the main flow section 12 and the flow insert 20 for the main flow section 12 and the flow insert 20. Purely by way of example, the tubular cross-sections of the main flow section 12 and the flow insert 20 are shown here as being round, whereby, however, one or both of these can, alternatively, be rectangular, elliptical or heart-shaped for example (see FIG. 7).

As indicated in FIG. 3a, the main flow section 12 includes a flow inlet 11 on a corresponding underside 17 of the main flow section 12 (the underside 17 is in particular a third side wall of the flow distributor 10) which is fluidically connected to the flow insert 20 therein. Thus, the media flow 1, which may contain for example air or fuel for the fuel cell stacks 40 (see FIG. 6a), can be introduced into the flow insert 20 and flow therein along the main flow section 12.

At one end of the flow insert 20, referred to here as the second end 23, there is a flow recess in the form of an end flow recess 24. For this purpose, the flow insert 20 is open at the second end 23. The second end 23 is opposite a first end 21, at which the flow inlet 11 is located. Through the end flow recess 24, the media flow 1 exits the flow insert 20 at the second end 23 and thus reaches the rear or last auxiliary flow sections 14, in the direction of flow or main direction of extension of the main flow section 12, and their auxiliary flow section openings 15, via the detour of the flow insert 20. The exiting media flow 1, as indicated by the corresponding arrows, which represent partial flow directions or partial media flows of the media flow 1, rebounds from a first side wall 13 (in particular upper side) transversely, in particular perpendicularly, to the second side wall 18 and opposite the flow inlet 11 and is deflected to the rear auxiliary flow sections 14.

In addition, besides the flow inlet 11 described, two second flow inlets 11 are formed on the underside 17 of the main flow section 12 and next to the first end 21 of the flow insert 20, or a particularly large flow inlet 11 is provided which is larger than a cross-section of the flow insert 20 at its first end 21. Through these two flow inlets 11 or the particularly large-dimensioned flow inlet 11, media flow 1 is also introduced into the main flow section 12, but without a detour via the flow insert 20. The media flow 1 introduced in this way can easily reach the front or first auxiliary flow sections 14 in the direction of flow or main direction of extension of the main flow section 12 and their auxiliary flow section openings 15.

The combination explained above of a media flow 1 which does not pass through the flow insert 20 to the first auxiliary flow sections 14 and one passing through the flow insert 20 to the last auxiliary flow sections 14 ensures that a good uniform distribution of the media flow 1 with regard to its mass, temperature and velocity is provided in all auxiliary flow sections 14. The last auxiliary flow section 14 is generously supplied with thermally insulated hot medium by the correspondingly dimensioned flow insert 20.

As FIG. 3a shows, the auxiliary flow section openings 15 of the auxiliary flow sections 14 are also of different sizes; here, by way of example, the auxiliary flow section openings 15 become increasingly large in the direction of flow. This is achieved by correspondingly dimensioned throttle elements in the auxiliary flow sections 14, as indicated in FIG. 3a, but also by way of example in FIGS. 4a, 5a, 6a. However, this can also be achieved, in addition or alternatively, by different-sized cross-sections of the auxiliary flow sections 14. This too makes it possible to make the distribution of the media flow 1 to the fuel cell stacks 40 more uniform.

FIG. 4a shows an alternative embodiment of the flow arrangement 30, compared to FIG. 3a, in which no end flow recess 24 is provided. Instead, the flow insert 20 extends entirely within the main flow section 12. In addition, intermediate flow recesses 22 are provided here in the flow insert 20 which, by way of example, are formed here on a side 26 of the flow insert 20 facing away from the auxiliary flow sections 14. In addition, the intermediate flow recesses 22 are here, by way of example, slit-shaped in form, with the slit length transverse to the main direction of extension of the flow insert 20. The individual intermediate flow recesses 22 are in each case at a distance from each other in the longitudinal direction of extension of the flow insert 20 and are in each case arranged at the flow height of the auxiliary flow sections 14. The dimension or number of the intermediate flow recesses 22 are advantageously designed differently according to the length of the distribution path.

As FIG. 4b shows, in the horizontal cross-section through the flow arrangement 30 (at the flow height of one of the auxiliary flow sections 24), a partial media flow of the media flow 1 is guided through the flow insert 20, in each case at the flow height of the intermediate flow recesses 22, against the second side wall 18, rebounds from this, flows around the flow insert 20 in the direction of the respective auxiliary flow section 14 and in this way reaches the respective fuel cell stack 40. The fact that this happens in each case at the flow height of the auxiliary flow sections 14 makes possible a uniformly distributed flow of the media flow 1 to the individual fuel cell stacks 40 and, as already mentioned above, with a lower angle of inclination, since this is homogenised by the flow insert 20 as it flows around this.

FIG. 5a shows yet another alternative embodiment of the flow arrangement 30 which shows a combination of a variation of the embodiment of FIG. 3a and the embodiment of FIG. 4a. FIG. 5b shows a horizontal cross-section above the end flow recess 24 of the flow insert 20. In contrast to FIG. 4a, the intermediate flow recesses 22 are formed on a side 25 of the flow insert 20 facing the auxiliary flow sections 14, as FIG. 5b shows. The combination of intermediate flow recesses 14 on the side 25 of the flow insert facing the auxiliary flow sections 14 and the side 26 of the flow insert facing away from the auxiliary flow sections 14 is also possible, as shown in FIG. 9.

FIG. 6a shows a fuel cell system 50 with a plurality of fuel cell stacks 40, each of which has inlet openings 42 for the media flow 1. The fuel cell stacks 40 can for example be polymer electrolyte membrane or solid oxide fuel cell stacks. The inlet openings 42 are fluidically connected to the auxiliary flow sections 14 of a flow arrangement 30 according to yet another exemplary embodiment. FIG. 6b shows a horizontal cross-section with respect to the flow arrangement 30 of FIG. 6a at the flow height of one of the auxiliary flow sections 14.

In a variation of the previous exemplary embodiments, a flow guide element 28 is arranged at each of the intermediate flow recesses 22 to guide the media flow 1 out of the respective intermediate flow recess 22, through the main flow section 12 into one of the auxiliary flow sections 14.

The flow guide elements 28 extend between the flow insert 20 and the main flow section 12. The arrangement shown in FIG. 6b of the flow guide elements 28 on the side 25 of the flow insert facing the auxiliary flow section 14 ensures that the partial media flow from the intermediate flow recesses 22 cannot flow directly to the respective auxiliary flow section 14. Instead, the partial media flow of the media flow 1 has to make the detour around the flow insert 20, so that the respective flow guide element 28 creates a flow vortex around the flow insert 20 which leads to the respective auxiliary flow section 14 after the flow insert 20 has been flowed around, in particular on all sides.

In addition, FIG. 6a shows an embodiment of the flow arrangement 30 in which the media flow 1 does not enter the main flow section 12 through an inlet opening 11 on its underside 17, but instead passes through an inlet section 16 which is branched off transversely from the main flow section 12 and can for example be designed as a tube. An optional further inlet section 16 is also shown at an approximately central flow height of the main flow section 12, through which a media flow 1 can be fed in addition.

FIG. 6b also shows an alternative design in which the flow insert 20 is flowed around almost completely in a clockwise direction, with an off-centre integration of the media flow 1, as a result of which the generated inflow swirl is formed and used further in the entire main flow section 12, as a result of which a particularly uniform inflow into the corresponding auxiliary flow section opening 15 is possible due to the longer flow paths.

FIG. 7 shows a variation of the embodiment of the flow arrangement 30 of FIG. 4b, in which the flow insert 20 has a heart-shaped cross-section instead of a round cross-section.

FIG. 8 shows, in a horizontal cross-section, an embodiment of the flow arrangement 30 which has two flow inserts 20 in a main flow section 12 which extend side by side, wherein the flow inserts 20 are by way of example formed according to the embodiment shown in FIGS. 4a and 4b. This design allows smaller installation spaces for the main flow section 12 and a large widening of the flow in the direction of the auxiliary flow sections 14, if this cross-section requires a wide but flat rectangular cross-section in the auxiliary flow section openings 14 due to lack of space.

Finally, FIG. 9 shows, in a horizontal cross-section, yet another embodiment of the flow arrangement 30 which has a flow insert 20 with a rectangular cross-section. Here, intermediate flow recesses 22 are arranged on both the side 25 of the flow insert facing the auxiliary flow sections 14 and on the side 26 of the flow insert facing away from the auxiliary flow sections 14. Furthermore, two inlet openings 11 are provided here with respect to the flow insert 20, as can be seen from the partial media flows within the flow insert 20 indicated by the arrows.

Finally, FIG. 10 shows yet another exemplary embodiment of a flow arrangement 30 according to the invention in which, in contrast to the exemplary embodiment of FIGS. 3a and 3b, by way of example only two auxiliary flow sections 14 are provided which, again by way of example, are arranged at the respective ends of the flow arrangement 30. In addition, the flow insert 20 in FIG. 10 is shortened compared to the flow insert 20 of FIGS. 3a and 3b, so that there is a greater distance between the first side wall 13 and the flow insert 20.

The preceding explanations of the embodiments describe the present invention exclusively in the context of examples.

### LIST OF REFERENCE SIGNS

1 media flow
10 flow distributor
11 flow inlet
12 main flow section
13 first side wall
14 auxiliary flow section
15 auxiliary flow section opening
16 inlet section
17 underside
18 second side wall
20 flow insert
21 first end
22 intermediate flow recess
23 second end
24 end flow recess
25 facing side of the flow insert
26 facing-away side of the flow insert
28 flow guide element
30 flow arrangement
40 fuel cell stacks
42 inlet opening
50 fuel cell system

1. Flow arrangement (30) for supplying a media flow (1) to inlet openings (42) of fuel cell stacks (40), wherein the flow arrangement (30) comprises a flow distributor (10) with a main flow section (12) and with auxiliary flow sections (14) branching off from the main flow section (12) for fluidic connection to the inlet openings (42) of the fuel cell stacks (40), and wherein a flow inlet (11) is formed in the main flow section (12) for supplying the media flow (1) into the main flow section (12), wherein the flow arrangement (30) further comprises a flow insert (20) arranged in the main flow section (12) and fluidically coupled with the flow inlet (11), with at least one flow recess (22, 24) for the uniformly distributed supply of the media flow (1) via the main flow section (12) and the auxiliary flow sections (14) to the inlet openings (42), wherein at least one of the at least one flow recesses (22, 24) is an intermediate flow recess (22) which is formed between a first end (21) and a second end (23) of the flow insert (20), characterised in that at least one of the at least one intermediate flow recesses (22) is formed on a side (26) of the flow insert (20) facing away from the auxiliary flow sections (14).

2. (canceled)

3. Flow arrangement (30) according to claim 12, wherein the flow insert (20) has a plurality of intermediate flow recesses (22) which are at a distance from each other along a main direction of extension of the flow insert (20).

4. Flow arrangement (30) according to claim 3, wherein in each case one of the intermediate flow recesses (22) is located at the flow height of one of the auxiliary flow sections (14).

5. (canceled)

6. Flow arrangement (30) according to claim 1, wherein a flow guide element (28) for guiding the media flow (1) out of the at least one intermediate flow recess (22) through the main flow section (12) into one of the auxiliary flow sections (14) is arranged on at least one of the at least one intermediate flow recesses (22).

7. Flow arrangement (30) according to claim 6, wherein the at least one flow guide element (28) is designed to generate a flow vortex of the media flow (1) around at least a part of the flow insert (20) and leading into one of the auxiliary flow sections (14).

8. Flow arrangement (30) according to claim 6, wherein the at least one flow guide element (28) runs between the flow insert (20) and a second side wall (18) of the main flow section (12) of the flow distributor (10).

9. Flow arrangement (30) according to claim 1, wherein at least one of the at least one intermediate flow recesses (22) is formed on a side (25) of the flow insert (20) facing one of the auxiliary flow sections (14).

10. Flow arrangement (30) according to claim 1, wherein the at least one intermediate flow recess (22) is designed in the form of a slit in the flow insert (20).

11. Flow arrangement (30) according to claim 1, wherein one of the at least one flow recesses (22, 24) is an end flow recess (24) which is formed at a second end (23) of the flow insert (20) remote from the flow inlet (11).

12. Flow arrangement (30) according to claim 1, wherein the flow distributor (10) has at least one further inlet opening (11) for supplying the media flow (1) past the flow insert (20) into the main flow section (12) and/or the inlet opening (11) is designed in such a way that the media flow (1) can be fed past the flow insert (20) into the main flow section (12).

13. Flow arrangement (30) according to claim 1, wherein the inlet opening (11) is formed on an inlet section (16) branching off from the main flow section (12).

14. Flow arrangement (30) according to claim 13, wherein at least one further inlet section (16) branching off from the main flow section (12) with an inlet opening (11) at a distance from the other inlet section (16) is formed in the main flow section (12).

15. Flow arrangement (30) according to claim 1, wherein at least two flow inserts (20) are arranged side by side in the flow distributor (10).

16. Flow arrangement (30) according to claim 1, wherein the flow insert (20) and/or the main flow section (12) is a tube.

17. Flow arrangement (30) according to claim 1, wherein the flow insert (20) is arranged concentrically with the main flow section (12).

18. Flow arrangement (30) according to claim 1, wherein auxiliary flow section openings (15) of the auxiliary flow sections (14) are of different sizes.

19. Fuel cell system (50) with a plurality of fuel cell stacks (40) and a flow arrangement (30) according to claim 1, wherein in each case an inlet opening (42) of each of the fuel cell stacks (40) is connected fluidically to a auxiliary flow section (14) of the flow distributor (10) of the flow arrangement (30).

20. Fuel cell system (50) according to claim 19, wherein the inlet openings (42) of the fuel cell stacks (40) lead to an air side or a fuel side of the fuel cell stacks (40).
